(19) United States
(12) Patent Application Publication
(10) Pub. No.: US 2007/0242195 A1
(43) Pub. Date: Oct. 18, 2007

(54) REFLECTIVE LIQUID CRYSTAL ON SILICON PANEL

(76) Inventors: Da-Shuang Kuan, Hsinchu County (TW); Tony Whitehead, Hsinchu City (TW); Chi-Tai Meng, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,640

(22) Filed: Apr. 17, 2006

(51) Int. Cl. G02F 1/1335

(52) U.S. Cl. 349/113

(57) ABSTRACT

A reflective liquid crystal on silicon panel (reflective LCOS panel) for polarizing a light beam and converting the light beam into an image is provided. The reflective LCOS panel includes a silicon substrate, an opposite substrate, a liquid crystal layer and a polarizer. The silicon substrate has a pixel array thereon. The opposite substrate is disposed over the silicon substrate and has a transparent electrode thereon. The liquid crystal layer fills up the space between the pixel array of the silicon substrate and the transparent electrode of the opposite substrate. The polarizer is set up on the silicon substrate or the opposite substrate. As described above, the integration of the polarizer with the reflective LCOS panel inside a projection apparatus can effectively reduce the cost, volume and weight of the projection apparatus.

### BACKGROUND OF THE INVENTION

1. Field of the Invention

The present invention relates to a liquid crystal display panel and a display apparatus. More particularly, the present invention relates to a reflective liquid crystal on silicon (LCOS) panel and a projection apparatus using the reflective LCOS panel.

2. Description of the Related Art

In recent years, liquid crystal display (LCD) has gradually replaces the conventional cathode ray tube (CRT) as the mainstream display device because LCD is lighter and slimmer and has a lower operating voltage and power consumption and a radiation-free operation. However, there are still a number of technical limitations imposed on the LCD devices. In general, the use of LCD is limited to a display product having a screen below 30 inches. For a display device having a screen between 30 inches to 60 inches, plasma display panel (PDP) should have a better future development. Nevertheless, the high cost of production has deterred consumers to accept this product.

As a result of the high cost of production of the PDP, display devices that utilize the projection technique, for example, the reflective projection display apparatus and the rear projection display apparatus, have a very good prospect in the marketplace. Both the reflective projection display apparatus and the rear projection display apparatus use a reflective liquid crystal on silicon (LCOS) panel. Because reflective LCOS panel has a low production cost, a high aperture ratio (up to 90%), a high resolution (the pixel size can be 12 μm or smaller), most major manufacturers have an agenda to develop such techniques.

At present, most reflective liquid crystal projection apparatuses have a polarizer and a dichroic mirror set up between its white light source and the LCOS panel. Furthermore, the polarizer and the dichroic mirror are independent optical elements and have no way to integrate with either the white light source or the LCOS panel. The polarizer polarizes the white light source and the dichroic mirror splits the polarized white light into three separate beams including a red beam, a green beam and a blue beam. Thereafter, the three beams are modulated by passing through three LCOS panels for matching with the image signals. Finally, through optical elements such as an X-cube and projection lenses, an integrated image is projected onto a screen. With the existing method of production, the polarizer and the dichroic mirror in the reflective liquid crystal projection apparatus are expensive to produce and hence will increase the overall production cost. Moreover, the optical path layout is also difficult. Therefore, reducing the cost of producing a reflective liquid crystal projection apparatus and reducing the complexity of the optical path layout are both major areas of research and development.

### SUMMARY OF THE INVENTION

Accordingly, the present invention is directed to provide a reflective liquid crystal on silicon (reflective LCOS) panel having a polarizer integrated therein to replace the polarizer of conventional light source system.

As embodied and broadly described herein, the invention provides a reflective liquid crystal on silicon (reflective LCOS) panel suitable for polarizing a light beam and converting the light beam into an image. The reflective LCOS panel includes a silicon substrate, an opposite substrate, a liquid crystal layer and a polarizer. The silicon substrate has a pixel array thereon. The opposite substrate is disposed over the silicon substrate and has a transparent electrode thereon. The liquid crystal layer is disposed between the pixel array of the silicon substrate and the transparent electrode of the opposite substrate. The polarizer is disposed on the silicon substrate or the opposite substrate.

In one embodiment of the present invention, the aforementioned pixel array includes a plurality of active devices and a plurality of pixel electrodes electrically connected to the respective active devices. In addition, the pixel electrodes can be reflective electrodes.

In one embodiment of the present invention, the aforementioned silicon substrate further includes an absorption layer disposed on the pixel array and a color mirror disposed on the absorption layer. At least a portion of the light beam having a wavelength within a specified range is reflected by the color mirror. Moreover, the remaining portion of the light beam not reflected by the color mirror is absorbed by the absorption layer.

In one embodiment of the present invention, the aforementioned reflective LCOS panel may further include a retarder disposed between the silicon substrate and the liquid crystal layer.

In one embodiment of the present invention, the pre-tilt angle of the aforementioned liquid crystal layer is substantially equal to the incident angle of the light beam.

In one embodiment of the present invention, the aforementioned polarizer may be a wire grid. In one preferred embodiment, the wire grid includes a plurality of parallel and equidistant conductive lines and each conductive line has a line width between 0.02 micrometer to 1.5 micrometer and a conductive line pitch between 0.02 micrometer to 2 micrometer.

In one embodiment of the present invention, the aforementioned opposite substrate is a rectangular substrate and an extending direction of the conductive lines and a side of the opposite substrate form an included angle of 45°.

In one embodiment of the present invention, the aforementioned polarizer is disposed on the opposite substrate such that the polarizer and the liquid crystal layer are disposed on the respective sides of the opposing plate.

In one embodiment of the present invention, the aforementioned polarizer is disposed on the opposite substrate and located between the liquid crystal layer and the opposite substrate.

In one embodiment of the present invention, the aforementioned polarizer is disposed on the silicon substrate and located between the liquid crystal layer and the silicon substrate.

In one embodiment of the present invention, the aforementioned reflective LCOS panel may further include a first alignment film disposed on the pixel array of the silicon substrate and a second alignment film disposed on the transparent electrode of the opposite substrate. Furthermore, the liquid crystal layer is oriented through the first alignment film and the second alignment film.

In one embodiment of the present invention, the aforementioned reflective LCOS panel may further include a protective layer disposed on the opposite substrate to cover the polarizer.

Because of the integration of the polarizer of the light source system integrated with the reflective LCOS panel in the present invention, not only is the cost of the manufacturing the projection apparatus lowered, but the overall weight and bulk of the projection apparatus are reduced as well.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A through 1C are schematic cross-sectional views of reflective liquid crystal on silicon panels according to a first embodiment of the present invention.

FIGS. 2A through 2C are schematic cross-sectional views of reflective liquid crystal on silicon panels according to a second embodiment of the present invention.

FIGS. 3A through 3C are schematic cross-sectional views of reflective liquid crystal on silicon panels according to a third embodiment of the present invention.

FIGS. 4A through 4C are top views of color mirrors.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

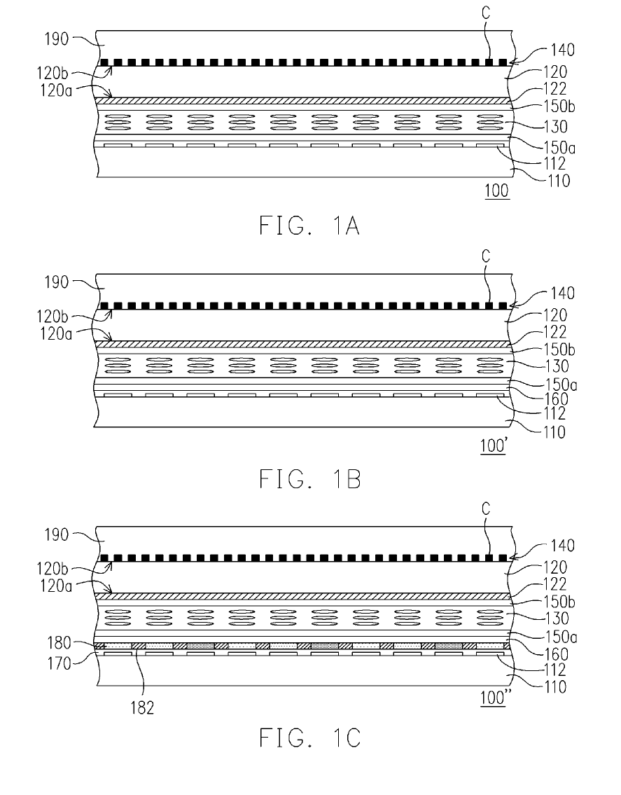

FIGS. 1A through 1C are schematic cross-sectional views of reflective liquid crystal on silicon panels according to a first embodiment of the present invention. As shown in FIG. 1A, the reflective liquid crystal on silicon (reflective LCOS) panel 100 of the present invention comprises a silicon substrate 110, an opposite substrate 120, a liquid crystal layer 130 and a polarizer 140. The silicon substrate 110 has a pixel array 112 formed thereon. The opposite substrate 120 is disposed above the silicon substrate 110 and has a transparent electrode layer 122. The liquid crystal layer 130 is disposed between the pixel array 112 of the silicon substrate 110 and the transparent electrode layer 122 of the opposite substrate 120. Furthermore, the polarizer 149 is disposed on the opposite substrate 110.

In the present embodiment, the silicon substrate 110 has a plurality of scan lines, a plurality of data lines, a plurality of active devices (for example, thin film transistors or other tri-polar active devices) and a plurality of pixel electrodes electrically connected to the active devices (for example, aluminum electrodes or other types of electrodes with a good reflectivity). The scan lines, the data lines, the active devices and the pixel electrodes on the silicon substrate 110 together constitute the so-called pixel array 112. Furthermore, the pixel array 112 is formed using optical films and sub-micron semiconductor fabrication techniques, for example.

The opposite substrate 120 is a glass substrate or other substrates with a high transmittance, for example. As shown in FIG. 1A, the transparent electrode layer 122 is located on the inner surface of the opposite substrate 120. In addition, the transparent electrode layer 122 is generally coupled to a common voltage. In one preferred embodiment, the transparent electrode layer 122 is fabricated using indium-tin-oxide (ITO), indium-zinc-oxide (IZO) or other transparent conductive material, for example.

In the present embodiment, the liquid crystal layer 130 between the pixel array 112 of the silicon substrate 110 and the transparent electrode layer 122 of the opposite substrate 120 can be any liquid crystal material suitable for the reflective LCOS panel 100. Furthermore, in order to align the liquid crystal molecules in the liquid crystal layer 130 according to design, the reflective LCOS panel 100 of the present embodiment may further include a first alignment film 150a and a second alignment film 150b. The first alignment film 150a is disposed on the pixel array 112 of the silicon substrate 110 and the second alignment film 150b is disposed on the transparent electrode 122 of the opposite substrate 120. As shown in FIG. 1A, the first alignment film 150a and the second alignment film 150b can orient the liquid crystal layer 130 in such a way that the liquid crystal molecules inside the liquid crystal layer 130 are aligned uniformly according to the design specification.

In one preferred embodiment, the pre-tilt angle of the liquid crystal molecules in the liquid crystal layer 130 is substantially equal to the incident angle of the light beam entering the reflective LCOS panel 100. Hence, the leakage of light from the reflective LCOS panel 100 in the dark state is improved and the contrast ratio of the image displayed on the reflective LCOS panel 100 is also enhanced. In general, the pre-tilt angle of the liquid crystal molecules and the angle of the incident light beam are set between 0.5° to 8°.

It should be noted that the reflective LCOS panel 100 has a built-in polarizer 140. Hence, there is no need for the reflective LCOS panel 100 of the present invention to match with a polarizer and analyzer in an optical engine. As shown in FIG. 1A, the polarizer 140 in the present embodiment is a wire grid disposed on the outer surface 120b of the opposite substrate 120. In other words, the polarizer 140 (the wire grid) and the liquid crystal layer 130 are disposed on the respective sides of the opposite substrate 120. More specifically, the wire grid includes a plurality of parallel and equidistant conductive lines C (for example, aluminum lines). The line width of each conductive line C is between 0.02 micrometer to 1.5 micrometer and the pitch of the conductive lines C is between 0.02 micrometer to 2 micrometer.

Accordingly, the extending direction of the conductive lines C will directly affect the polarization of the light passing through the wire grid. In the reflective LCOS panel 100 of the present embodiment, the light after passing through the wire grid is linearly polarized. Furthermore, the direction of polarization of the linearly polarized light may be perpendicular to the extending direction of the conductive lines C. In one preferred embodiment of the present invention, the opposite substrate 120 is a rectangular substrate and the extending direction of the conductive lines C is set at an included angle of 45° with respect to the side of the opposite substrate 120. Obviously, the extending direction of the conductive lines C can be adjusted to obtain a linearly polarized light having a specified direction of polarization according to the actual requirements of the product.

As shown in FIG. 1A, the reflective LCOS panel 100 further includes a protective layer 190 disposed on the outer surface 120b of the opposite substrate 120 such that the polarizer (the wire grid) 140 can be covered and protected by the protective layer 190. In the present embodiment, the protective layer 190 is a dielectric layer with a high transmittance, for example.

As shown in FIG. 1B, the reflective LCOS panel 100′ is similar to the reflective LCOS panel 100 shown in FIG. 1A. The main difference is that the reflective LCOS panel 100′ in FIG. 1B has an additional retarder 160 disposed between the silicon substrate 110 and the liquid crystal layer 130. Furthermore, the retarder 160 is located between the first alignment film 150a and the pixel array 112. In the present embodiment, the retarder 160 is a quarter wave plate or other retarder having different retardation.

As shown in FIG. 1C, the reflective LCOS panel 100″ is similar to the reflective LCOS panel 100′ shown in FIG. 1B. The main difference is that the reflective LCOS panel 100″ in FIG. 1C has an additional absorption layer 170 and a color mirror 180. The absorption layer 170 and the color mirror 180 provide an effective means of improving the reflectivity of the reflective LCOS panel 100″, and therefore, improving the overall display quality. The absorption layer 170 is disposed on the pixel array 112 and the color mirror 180 is disposed on the absorption layer 170 (between the color mirror 180 and the retarder 160). The color mirror 180 can reflect at least a portion of the light beam within a specified wavelength range while remaining portion of the light beam not reflected by the color mirror 180 can be absorbed by the absorption layer 170.

The color mirrors 180 in FIG. 1C are disposed in the pixel array 112 above the pixel electrodes. Furthermore, there is a black matrix 182 disposed between neighboring color mirrors 180. The absorption layer 170 can be fabricated using a black light-absorbing material including titanium nitride, tungsten, chromium or molybdenum, for example. It should be noted that the color mirrors 180 in the present embodiment has a multi-layered structure, for example. The multi-layered structure includes at least a high refractive index layer and at least a low refractive index layer. Furthermore, the high refractive index layer and the low refractive index layer stack alternately over each other. Through the material and thickness selection of the high refractive index layer and the low refractive index layer, the multi-layered color mirror 180 can reflect light of a specified spectrum range (for example, red light, blue light, green light, cyan light, yellow light, magenta light, infrared light and so on). The light not reflected by the color mirror 180 will pass through the color mirror 180 to reach the underlying absorption layer 170. In one preferred embodiment, the material constituting the color mirror 180 includes tantalum oxide, titanium oxide or silicon oxide, for example. Because the color mirrors 180 are fabricated using inorganic material, they have to capacity to withstand the illumination of a highly energetic light beam.

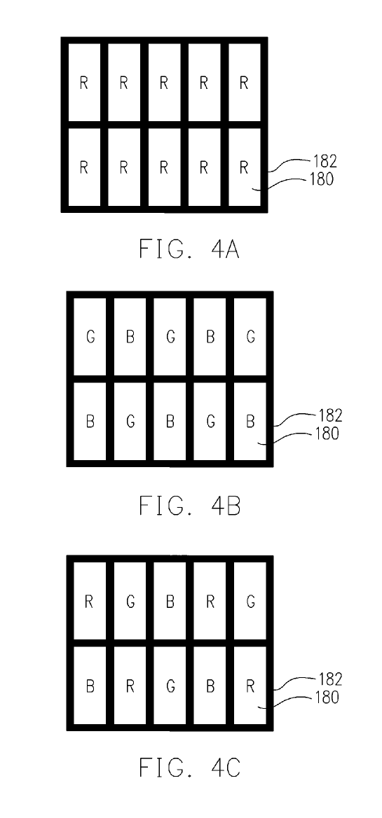

Since the color mirrors 180 may include an optical structure for reflecting single color light, one of the following lights including red light, blue light, green light, cyan light, yellow light and magenta light is reflected. As shown in FIG. 4A, the color mirror 180 in each pixel unit is used for reflecting red (R) light. Obviously, the color mirror 180 in each pixel unit can be designed to reflect green light, blue light, cyan light, yellow light or magenta light.

In another embodiment, the color mirrors 180 above the pixel array 112 may include two types of optical structures for reflecting different color lights. Therefore, the color mirrors 180 can reflect two of the color lights selected from a group consisting of red light, blue light, cyan light, yellow light or magenta light. As shown in FIG. 4B, the color mirrors 180 for reflecting the green (G) light and the blue (B) light are alternately arranged. Obviously, the arrangement of the color mirrors 180 of the present invention is not limited. Furthermore, the two types of color reflective structures can be used to reflect any combination of two colors selected from the group consisting of red light, blue light, green light, cyan light, yellow light and magenta light.

In another preferred embodiment, the color mirrors 180 disposed on the pixel array 112 may include three types of optical structures for reflecting different color lights. Therefore, the color mirrors 180 can reflect three of the colors in the group consisting of red light, blue light, green light, cyan light, yellow light and magenta light. For example, in FIG. 4C, the three types of color mirrors 180 can reflect red (R) light, green (G) light and blue (B) light with the ordering sequence of the first row being RGB and the ordering sequence of the second row being BRG. Similarly, the ordering sequence and the alignment pattern in the present invention are not limited to any particular way.

In addition, the color mirrors 180 in the present invention can be designed to have four or more optical structures for reflecting four or more color lights selected from the group consisting of red light, blue light, green light, cyan light, yellow light and magenta light.

The reflective LCOS panel 100″ in the present invention uses color mirrors 180 to reflect the required color lights and the absorption layer 170 to absorb any non-reflected light. Thus, this type of reflective LCOS panel 100″ has superior reflectivity. In other words, the reflective LCOS panel 100″ in the present invention has a much better reflectivity than the conventional reflective LCOS panel having a reflective layer fabricated using simply aluminum.

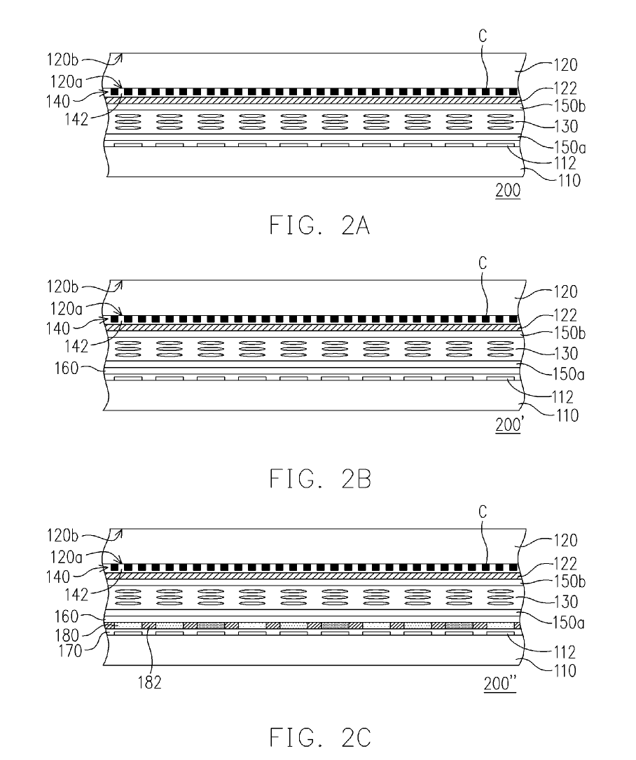

FIGS. 2A through 2C are schematic cross-sectional views of reflective liquid crystal on silicon panels according to a second embodiment of the present invention. As shown in FIGS. 2A through 2C, the reflective LCOS panels 200, 200′ and 200″ are similar to the reflective LCOS panel 100, 100′ and 100″ in the first embodiment. The major difference is that the polarizer 140 (the wire grid) of the reflective LCOS panels 200, 200′, 200″ in the present embodiment is disposed on the inner surface 120a of the opposite substrate 120. Specifically, the polarizer 140 is located between the liquid crystal layer 130 and the opposite substrate 120.

As shown in FIGS. 2A through 2C, the polarizer 140 (wire grid) on the inner surface 120a of the opposite substrate 120 is covered by a dielectric layer 142. Furthermore, the dielectric layer 142 that covers the polarizer 140 (wire grid) has a planar surface and the transparent electrode layer 122 is formed on the planar surface of the dielectric layer 142.

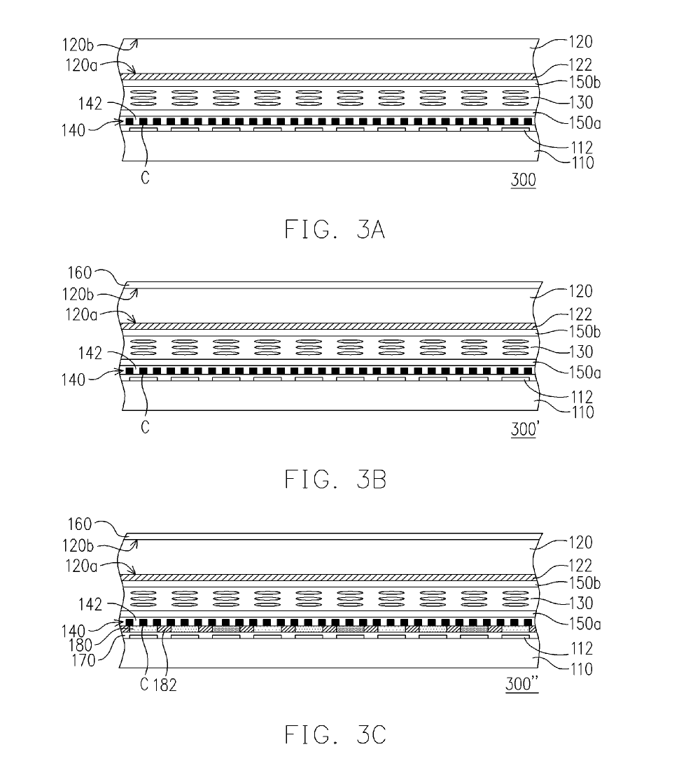

FIGS. 3A through 3C are schematic cross-sectional views of reflective liquid crystal on silicon panels according to a third embodiment of the present invention. As shown in FIGS. 3A through 3C, the reflective LCOS panels 300, 300′ and 300″ are similar to the reflective LCOS panel 100, 100′ and 100″ in the first embodiment. The major difference is that the polarizer 140 (the wire grid) of the reflective LCOS panels 300, 300′, 300″ in the present embodiment is disposed on the silicon substrate 110. Specifically, the polarizer 140 is located between the liquid crystal layer 130 and the silicon substrate 110.

As shown in FIGS. 3A through 3C, the polarizer 140 (wire grid) is covered by a dielectric layer 142. Furthermore, the dielectric layer 142 that covers the polarizer 140 (wire grid) has a planar surface and the first alignment film is formed on the planar surface of the dielectric layer 142.

In summary, the reflective liquid on silicon panel in the present invention has at least the following advantages:

1. Since the polarizer (the wire grid) is integrated with the reflective LCOS panel in the present invention, light entering the reflective LCOS panel can be polarized through the built-in polarizer. Without the need to combine with other polarizer or analyzer, the production cost is reduced. In addition, the overall weight and volume of the projection apparatus can also be minimized.

2. Since the color mirrors, the absorption layer and the polarizers (the wire grids) are integrated with the reflective LCOS panel in the present invention, the production cost and the weight and the volume of the projection apparatus can be further reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A reflective liquid crystal on silicon (LCOS) panel suitable for polarizing a light beam and converting the polarized light beam into an image, the reflective LCOS panel comprising:
a silicon substrate having a pixel array thereon;
an opposite substrate disposed above the silicon substrate, wherein the opposite substrate has a transparent electrode layer;
a liquid crystal layer disposed between the pixel array of the silicon substrate and the transparent electrode layer of the opposite substrate; and
a polarizer disposed on the silicon substrate or the opposite substrate.

2. The reflective LCOS panel of claim 1, wherein the pixel array further comprises:
a plurality of active devices; and
a plurality of pixel electrodes electrically connected to the respective active devices.

3. The reflective LCOS panel of claim 2, wherein the pixel electrodes are reflective electrodes.

4. The reflective LCOS panel of claim 1, wherein the silicon substrate further comprises:
an absorption layer disposed on the pixel array; and
a color mirror disposed on the absorption layer, wherein at least a portion of the light beam having a wavelength within a specified range is reflected by the color mirror and the remaining portion of the light beam not reflected by the color mirror is absorbed by the absorption layer.

5. The reflective LCOS panel of claim 1, further comprising a retarder disposed between the silicon substrate and the liquid crystal layer.

6. The reflective LCOS panel of claim 1, wherein the pre-tilt angle of the liquid crystal layer is substantially equal to the incident angle of the light beam.

7. The reflective LCOS panel of claim 1, wherein the polarizer is a wire grid.

8. The reflective LCOS panel of claim 7, wherein the wire grid further comprises a plurality of parallel and equidistant conductive lines, each conductive line has a line width between 0.02 micrometer to 1.5 micrometer and the pitch of the conductive lines is between 0.02 micrometer to 2 micrometer.

9. The reflective LCOS panel of claim 7, wherein the opposite substrate is a rectangular substrate and an extending direction of the conductive lines and a side of the opposite substrate form an included angle of 45°.

10. The reflective LCOS panel of claim 1, wherein the polarizer is disposed on the opposite substrate such that the polarizer and the liquid crystal layer are located on the respective sides of the opposite substrate.

11. The reflective LCOS panel of claim 1, wherein polarizer is disposed on the opposite substrate and located between the liquid crystal layer and the opposite substrate.

12. The reflective LCOS panel of claim 1, wherein the polarizer is disposed on the silicon substrate and located between the liquid crystal layer and the silicon substrate.

13. The reflective LCOS panel of claim 1, further comprising:
a first alignment film disposed on the pixel array of the silicon substrate; and
a second alignment film disposed on the transparent electrode of the opposite substrate, wherein liquid crystal molecules of the liquid crystal layer are oriented through the first alignment film and the second alignment film.

14. The reflective LCOS panel of claim 1, further comprising a protective layer disposed on the opposite substrate to cover the polarizer.
